(19) United States
(12) Patent Application Publication
(10) Pub. No.: US 2002/0072938 A1
(43) Pub. Date: Jun. 13, 2002

(54) Ground transportation internet reservation system

(76) Inventors: Christopher M. Black, Tarzana, CA (US); Gregg L. Tuccillo, Morganville, NJ (US)

Correspondence Address: Melvin K. Silverman, Suite 2600, One Gateway Center, Newark, NJ, 07102, US

(21) Appl. No.: 09/924,804

(22) Filed: Aug. 9, 2001

Related U.S. Application Data
(60) Provisional application No. 60/227,038, filed on Aug. 23, 2000.

(51) Int. Cl. G06F 17/60

(52) U.S. Cl. 705/5

(57) ABSTRACT

An on-line/Internet interface between the public, travel agencies, corporate travel offices and the over 9,000 car service companies to handle various back office billing and record keeping functions, to make available chauffeured vehicle services on a basis comparable to that of other historic elements of the travel industry.

### REFERENCE TO RELATED APPLICATION

This case is a non-provisional utility application conversion of Application Serial No. 60/227,038, filed Aug. 23, 2000. We hereby claim the benefit and priority of the filing date under 35 U.S.C.(119)(e) of the aforesaid provisional application and, as well, incorporate the same by reference herewith.

### BACKGROUND OF THE INVENTION

1. Area of Invention

An on-line reservation system, particularly for chauffeured car services, for use with industry specific reservation systems inclusive of airline, hotel and rental car systems and with the public through an Internet interface.

2. Prior Art

The prior art of reservation systems is characterized primarily by existing airline, hotel, rental car and travel agency systems, generically referred to as legacy systems. The largest of systems of this type are WorldSpan (owned principally by TransWorld Airlines, Delta, and Northwest), Sabre which is related to American Airlines, Galileo which is related to United Airlines, and Amadeus which is the largest travel related computer reservation network in Europe. These computer reservation system (CRS) networks have, historically, been used principally by travel agencies and travel offices of corporations. While hotel and car rental agencies have become associated with the CRS legacy networks, the chauffeured car service has never become a part of these historic systems.

Chauffeured car services, as an industry, constitute a mix of general-purpose ground transportation service companies that provide privately chauffeured sedans, limousines, and passenger vans. Approximately one half of all chauffeured trips are for business purposes including, most commonly, transportation to or from an airport. More detailed information with regard to the limousine and chauffeured car industry is available from that industry's association website, namely, limousinecentral.com. Single fares for this market typically fall in a range of $50 to $100. The present invention seeks to facilitate an on-line market niche for this business.

At present, the chauffeured car industry is highly fragmented. There is no dominant operator, such as Hertz, as exists in the rental car area. For example, even in the New York metropolitan area, which is served by major ground service companies at all airports, no single operator possesses more than a two-percent share of the market. While there is a trend toward consolidation, the total number of cars serviced in companies operating nationally has in fact declined in recent years from 9,600 to 9,100. However, the global fleet of chauffeured vehicles is estimated at about 200,000 and is now growing, principally as a result of the strong economy of recent years. It has long been known that most service car companies do not make efficient use of their fleets, the size of which averages about twenty vehicles per company. To improve such efficiency, a sophisticated, publicly accessible, on-line reservation system is necessary. Historically, this has not been practical and has been too expensive for most chauffeured car service providers to create on their own and, in addition, most such service providers have been unable to afford the cost of a CRS legacy network terminal, as is held by the larger travel agencies, which is necessary to enter this market. Accordingly, the chauffeured car industry, because of its fragmentation and lack of organization, has been unable to effect meaningful access to the global travel transportation system which exists today in other travel related industries.

The present invention may, therefore, be viewed as a response to the above set forth need in the ground transportation industry for appropriate interface with both legacy CRS systems and the public through an appropriate public user interface thereto and to existing limousine clients whose use would, in all likelihood, increase at airports outside of one's home area if an appropriate networking arrangement were in place within the presently fragmented chauffeured car industry.

The prior art, as it appears as issued U.S. patents, includes the above-referenced Sabre and WorldSpan systems which, in some geographies, are linked by means of a system known as Transponent, as reflected in U.S. No. 5,953,706 (1999) to Patel, entitled Transportation Network System. The Transponet system is used to facilitate referral and cross-referral arrangements between existing travel professionals is not intended for use by the general public, and does not contemplate use of customized data structures using intelligent software agents for the selection of ground transportation service providers matched to defined criteria of both the system user and the network operator.

Further, systems exist having, as their purpose, the rendering of systems as said Sabre and WorldSpan carrier easier to use. These systems are represented by U.S. Pat. No. 5,842,176 (1998) to Hunt, entitled Method and Apparatus For Interacting With A Computer Reservation System.

Sophisticated hotel and cruise information booking and processing systems are known as is reflected in U.S. Patent Nos. 5,864,818 (1999) to Feldman; and No. 4,788,643 (1988) to Trippet, et al.

It is also known to employ intelligent or virtual software agents in order to “shop” for travel factors such as lowest price, most liberal cancellation policy, short notice bookings, and the like. Software of this type is represented by U.S. Pat. No. 5,832,454 (1998) to Jafri, et al entitled Reservation Software Employing Multiple Virtual Agents; U.S. Pat. No. 5,926,798 (1999) to Carter, entitled Method And Apparatus For Performing Computer Based On-Line Commerce Using An Intelligent Agent; and U.S. Pat. No. 5,253,165 (1993) to Leiseca, et al, entitled Computerized Reservations And Scheduling System. Accordingly, the prior art while generally sophisticated does not address the specific issues and inefficiencies historically associated with the reservation of chauffeured vehicles which are addressed herein.

3. Response to Prior Art

In light of the above, the present invention provides an online/Internet interface between the public, travel agencies, corporate travel offices and the over 9,000 car service companies which exist and, as well, means to handle various back office billing and record keeping functions, to thereby make available to chauffeured vehicle services on a basis comparable to that of other historic elements of the travel industry.

Currently, a chauffeured car reservation from a corporate travel manager can take from a few minutes to more than an hour to confirm. This is the result of any of a number of factors inclusive of a telephone busy signal or answering machine, or the unavailability of a reservation clerk at the time of a phone call. During such delays, a standard passenger name record (“PNR”) cannot be completed until the car service reservation is finalized. Therein, the agent must remember to re-open the PNR later, after the car service arrangements have been made. This disjointed reservation process can, and often does, result in errors during the process of reserving a chauffeured car. Some travel agencies will transfer clients and their PNRs to a special limousine desk within their office after airline and hotel reservations are complete. In other words, the vagaries of chauffeured car service reservation is often such that an ordinary travel agent is not able to deal with the same. Therefore, the need for a special desk within a large travel agency or corporate travel department.

Another issue which has limited the integration of the chauffeured car industry into traditional travel related services is that travel counselors are often compensated in relation to the dollar volume of travel which they can reserve per hour. In the case of the limousine business, the often inordinate phone time required to properly reserve a car service, and to handle all the record keeping and billing associated therewith, has rendered it uneconomical for most company travel department or travel agency to handle limousine reservations.

The present invention therefore addresses the above set forth issues, inefficiencies and limitations historically associated with the reservation of a chauffeured car service.

### SUMMARY OF THE INVENTION

The instant system includes two basic technical components, namely, a centralized server using Microsoft NT Cluster (or equivalent) technology, located at an administrative headquarters through which all transactions must past and, secondly, several software modules usable, as below set forth, through the historic CRS network, the public and car service companies through Internet access. The hardware and software of the system are interfaced through a so-called open database connectivity (“ODBC”) front end, also termed an ODBC interface layer module. The system also includes a centralized database module which is rendered compatible with the ODBC interface layer through the use of Microsoft standard query language (“SQL”). Reservation requests from both CRS systems and the Internet are acquired through a queue detect module which receives PRN and XML texts from a user interface to determine when a reservation request exists, whereupon the same is forwarded to a parsing module which effects full acquisition of the reservation request and, as well, originates a reservation transaction by passing the acquired reservation onto a reservation validation module. Once validated, reservation information is stored both in the company's database via the ODBC facility and is also referred to inventive reservation and rate determination routines to determine reservation allocation, as between various members for a geographical area within a service provider database Therein is made a best rate or best provider selection pursuant to criteria programmed into the system. Accordingly, through a provider allocation module, the desired ground service, using either a best rate or best provider criteria, will distribute the reservation to a qualified service provider whereupon such service provider will either accept or reject the invitation to render the service requested. This invitation is effected through a service provider distribution module. After a provider reservation confirmation has been obtained, a reservation confirmation is communicated to the originating entity, namely, an airline CRS system or an on-line/Internet based customer. Therein, an itinerary is forwarded which includes particulars of pick-up time, drive time, drop-off time, rate, and method of payment. This will initiate a billing trigger function, as a part of a general reservation reconciliation, in which billing is facilitated in the manner specified in a client/customer database. For larger customers there is provided a corporate administration and reporting module.

In view of the above, it is to be appreciated the inventive ground transportation reservation system includes at least one remote client computer inclusive of means for generation and transmitting reservation requests and related date therefrom; at least one remote service provider computer; a local host computer and server having a network connection with both of said remote computers, said connection allowing data transfer between a host on the one hand and a client and a service provider respectively on the other hand. Within said host server is provider means for acquisition and formatting of data of a received reservation request to form a reservation record. Also provided is means for validating said reservation record, for making later changes thereto, and entering said validated record into a first data structure of an operating system of said host server. The inventive system, importantly, also includes an intelligent software agent comprising an algorithm for selecting a service provider for task execution of said validated record, the algorithm includes (i) a second data structure of member service providers; (ii) means for applying to said validated record combinations of client and host specified criteria of provider rates, geographical data, vehicle type, vehicle availability, personnel inclusive of languages spoken, insurance type held by the service provider, and ranking by server-determined qualification; and (iii) means for resolving algorithmic ties or deadlocks between providers on a basis of host ranking, a rotating list of providers, or a random function thereof. A remote client may also access said second data structure to directly select a service provider according to information obtained therefrom but without otherwise employing said intelligent software agent.

After selection of a service provider by either said intelligent agent or the client, the first selected service provider is provided is advised, through said network connection, of its selection for execution of said reservation record. The system further includes means for obtaining a confirmation of acceptance of an offer of said record from the selected service provider. There is further provided means for reiterating use of said intelligent agent if said first selected provider declines execution of said reservation record or does not respond to an offer thereof. Finally, the system includes means for entering all accepted records into a third data structure and advising said client of the identity of the finally selected provider and the itinerary associated therewith.

It is accordingly an object of the invention to provide an on-line reservation system interfacable with divergent software front ends without requirement for custom interfaces at each point of entry to the system.

It is another object to provide an on-line reservation system adapted for front end interaction with all airline and travel CRS legacy systems, web-based inputs from the public, service provider inputs, and corporate and administrative search engines.

It is a further object of the invention to provide a reservation system of the above type that will place ground transportation, inclusive of chauffeured vehicles, upon an equal reservation footing as historically has it as existed for airlines, hotel and rental cars industries.

It is a yet further object to provide an Internet-based ground transportation reservation system capable of providing to travel agents and travel planners sufficient compensation to render reservations of individual ground trips competitive relative commissions to agents in other historic travel areas.

It is a still further object of the invention to provide a reservation system capable of on-line reservation acquisition, reservation validation, reservation provider and rate determination, reservation distribution, and confirmation of acceptance of reservation by a service provider.

It is another object to provide a system having databases of service providers in categories of geography, vehicle inventory, performance criteria, insurance and rate criteria, in association with a customer reservation database usable in association with a variety of “back office” or close-out functions inclusive of issuance of itineraries and periodic billing to customers in a requested fashion and format.

The above and yet other objects and advantages will become apparent from the hereinafter set forth Brief Description of the Drawings and Detailed Description of the Invention as set forth herein.

### BRIEF DESCRIPTION OF THE DRAWINGS

FIG. 1 is a block diagrammatic overview view of the inventive system.

FIG. 2 shows, in flow diagram form, the relationship between the system user interface module, the queue detect module, and the parsing module.

FIG. 3 is a flow diagram view of the reservation validation aspect of the system.

FIG. 4 is a flow diagram of the service provider allocation module.

FIG. 5 is a flow diagram of a best rate selection routine employed within the service provider allocation module.

FIG. 6 is a flow diagram of a best service provider selection routine using non-rate criteria, within the service provider allocation module.

FIG. 7 is a flow diagram of the service provider distribution module relative to the system reservation database and the user interface module.

FIG. 8 is a flow diagram of the portion of the system showing confirmation of a service provider reservation record acceptance.

FIG. 9 is a flow diagram of the basic reconciliation/closeout/bookkeeping aspects of the present invention.

FIG. 10 is a screen view of the host console relating to unresolved queues, that is, client reservations that cannot be processed.

FIG. 11 is a screen view at the monitor of an operator/service provider showing the pending queue for that operator.

FIG. 12 is a screen view of a system operator queue of unaccepted operator reservations as appears upon a host administrator console.

FIG. 13 is a screen view of the monitor of the so-called active queue, that is, active pickups and deliveries of end users in process for a particular service provider.

FIG. 14 is a screen view of the rate maintenance screen of an operator/service provider which enables the provider to furnish updated rates to the host computer server.

FIG. 15 is a screen view, similar to that of FIG. 14, showing the screen which enables the operator/service provider to generate a new rate where, for example, a new vehicle type or a first time destination for a given vehicle type occurs.

FIG. 16 is an operator screen through which a service provider may quote to a client end user rates of remote operators situated at a flight or itinerary destination point of the end user.

FIG. 17 is a view of a client screen which enables a new client to register upon the inventive system for the first time.

FIG. 18 is a view, further to that of FIG. 17, showing profile information to be filled in by a new client.

FIG. 19 is a view of an Internet reservation screen which enables a client to make a reservation using the present system.

FIG. 20 comprises a lower portion of FIG. 19.

FIG. 21 shows an Internet user screen for enabling a client to insert parameters for use by the system intelligent software agent to select a service provider in accordance with the wishes of the client but subject to host-specified criteria such as insurance level and ranking of the service provider by host determined qualifications.

FIG. 22 is a reservation verification page as seen by a system client.

FIG. 23 is a confirmation page for use by a system client.

### DETAILED DESCRIPTION OF THE INVENTION

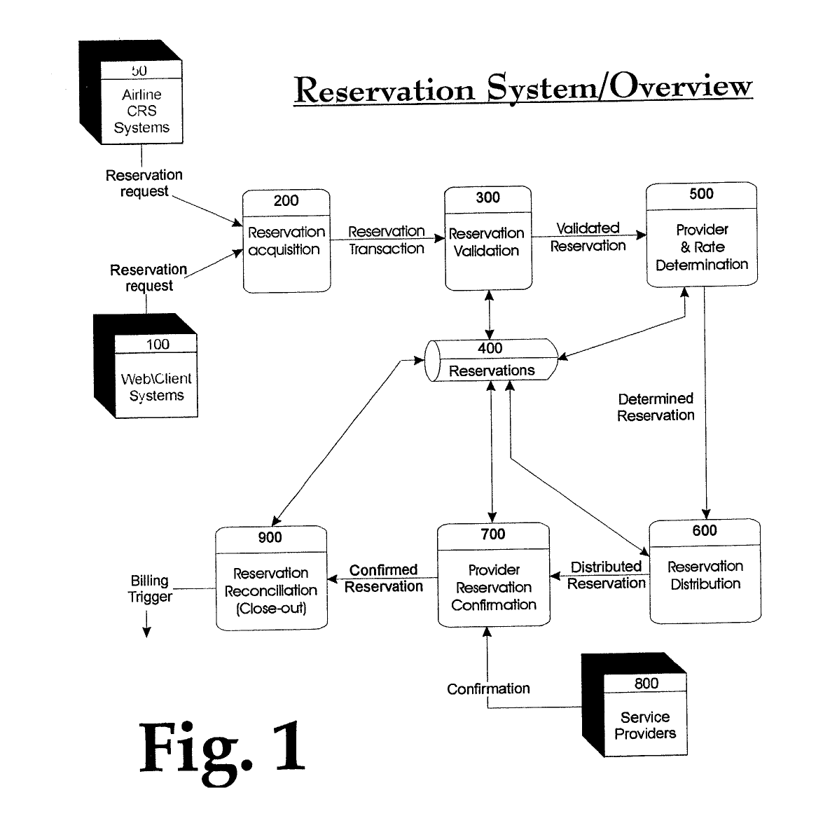

With reference to FIG. 1, there is shown, in block diagram form, an overview of the present Internet reservation system.

Therein, the sources of reservation requests may be seen to include a legacy airline CRS system 50 and web or an Internet based client system 100. Through a queue detect module and parsing module, both described below, reservations from sources 50 and 100 are secured. Therefrom, a reservation transaction is initiated which will result in a reservation validation 300 which is then inputted both into a reservation database 400 and is forwarded onto a service provider allocation module, described below, which is shown as a provider and rate determination step 500 in FIG. 1. Therein, through the use of a novel algorithm, the particular provider most applicable to the reservation request 50 or 100, and to the systems own criteria, is identified, as is the rate for the requested trip. This information is furnished both to the reservation database 400 and is acted upon at reservation distribution step 600 which employs a service provider distribution module, described below. The output of step 600 is furnished both to the reservation database 400 and to a provider reservation confirmation/acceptance step 700. The fact of a confirmation or acceptance of an assignment is received from a service provider 800 and communicated to reservation database 400. An on line confirmation is received both by a system administrator and the ultimate customer. Thereafter, the confirmed reservation is passed on to a reservation reconciliation or closed-out module 900 which includes a billing trigger for purposes of invoicing in accordance with the billing information, preferences and protocols stored by the system with reference to the particular customer from which the reservation request 50 of 100 originated.

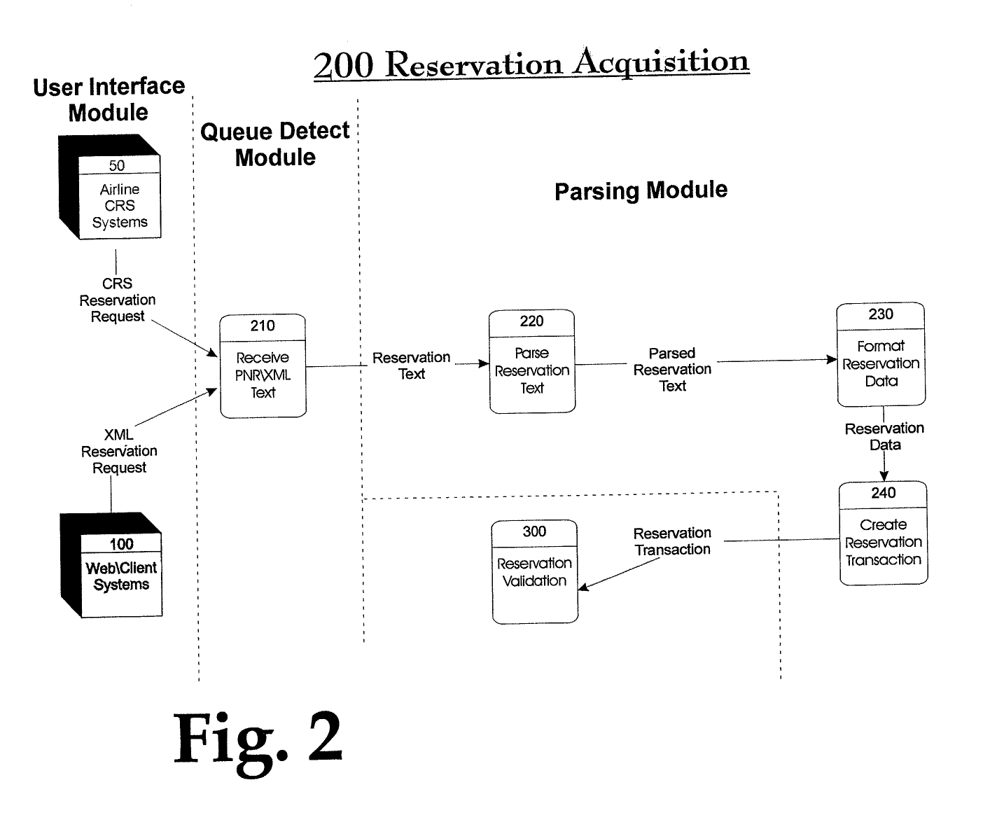

With reference to FIG. 2, the particulars of the reservation acquisition process are shown in greater detail. Shown therein is the relationship between a user interface module which acquires all reservation request information, whether in CRS or XML format, and forwards the same to a queue detect module 210, the function of which is to receive the PNR (passenger numerical record) information from the airline CRS system 50 or the web based client 100 of the user interface module. This is accomplished through a continual monitoring, e.g., once every minute, of the user interface module by the queue detect module.

After PNR or XLM text has been received and appropriately formatted by the queue detect module 210, the same is communicated, in a reservation text or format usable by a parsing module which performs the following functions:

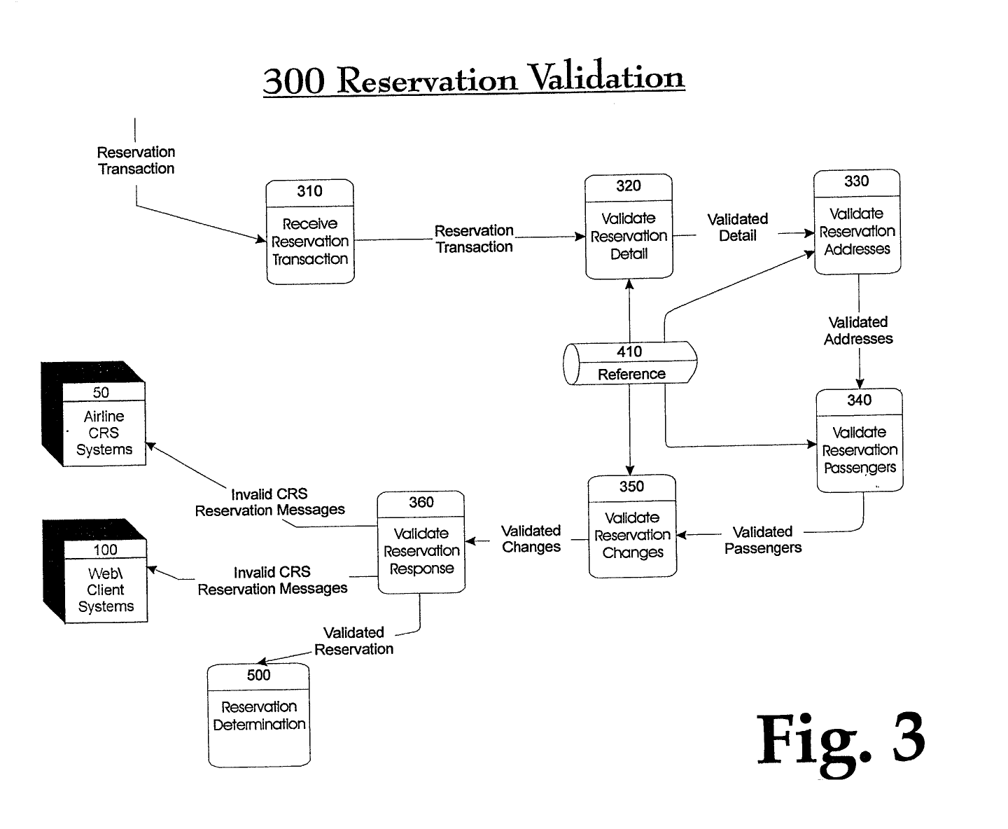

Firstly, the reservation text is parsed (separated in accordance with the protocol of the parsing module) at step 220, whereupon the parsed reservation text is forwarded onto a format reservation data step 230 which effects appropriate formatting of the parsed data. This information is, in turn, forwarded to step 240 which employs the formatted reservation data to create a reservation transaction which comprises the output of the parsing module and, thereby, the input of the reservation validation 300, which function is shown in greater detail in FIG. 3.

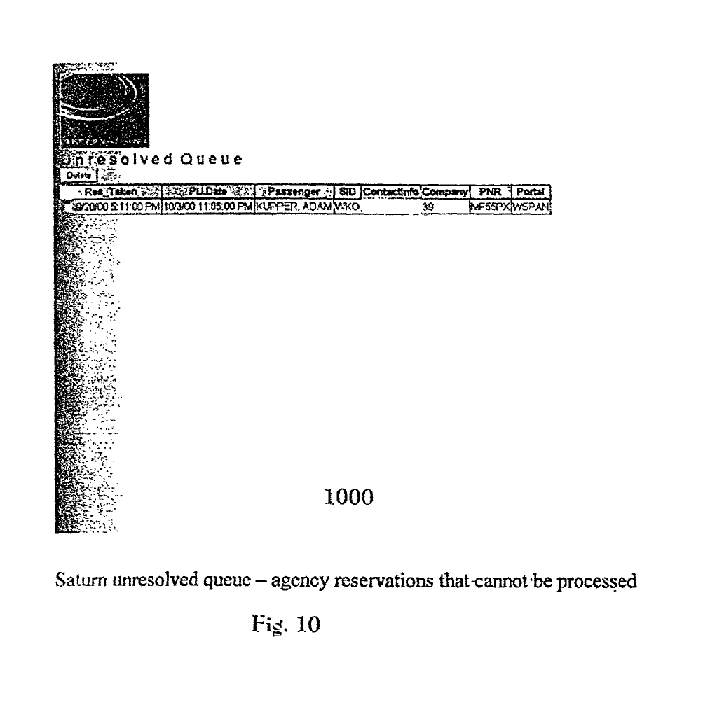

More particularly, in FIG. 3 are shown the various steps which are included in the validation of a reservation. That is, after receipt of the reservation transaction at step 310, such information is forwarded to step 320 which validates the details of the reservation using, where available, stored historic information from reference database 410 (which is a part of the larger reservation database 400 referenced above). Thereby, at step 330, the reservation address is validated and, therefrom, the address of the validated reservation is passed onto step 340. As may be noted from the loop consisting of step 330, step 340, and database 410, the address information may be checked as many times as is necessary to answer questions the system may have relative to discrepancies in address or name data relative to historic information in the system with regard to the particular customer. After the passenger address and passenger name (which may include issues of individual name versus corporate name and corporate billing name) are determined, fully confirmed and validated information is then forwarded to step 350 whereat any changes in the reservation may be acted upon. For example, if there is a change of any type in a given reservation between the time of origination of the reservation request and the time of anticipated dispatch by the service provider, the system will act upon such reservation changes moving through steps 310, step 320, database 410 and step 350, therein making the appropriate reservation change without reference to steps 330 and 340 since it is not necessary to re-validate address or passenger/company name. In other words, if a change in either address or customer were to occur, the same would be viewed as a new transaction by the system, as opposed to a reservation change. From step 350 the reservation, inclusive of validated changes, is forwarded to step 360 which produces a to validate reservation response by the system. In most cases, this will entail forwarding of the validated reservation to the service provider allocation module 500 (discussed below); however, in the event of an invalid input from either airline systems 50 or web based client 100, an invalid CRS reservation message will be returned, through the client user interface module, indicating that the system is unable to validate the information for reasons of either name, address or phone number of the provider. Such a condition is shown in FIG. 10 as screen 1000 which shows an “unresolved queue” that is, agency reservations which, for whatever reason, cannot be processed.

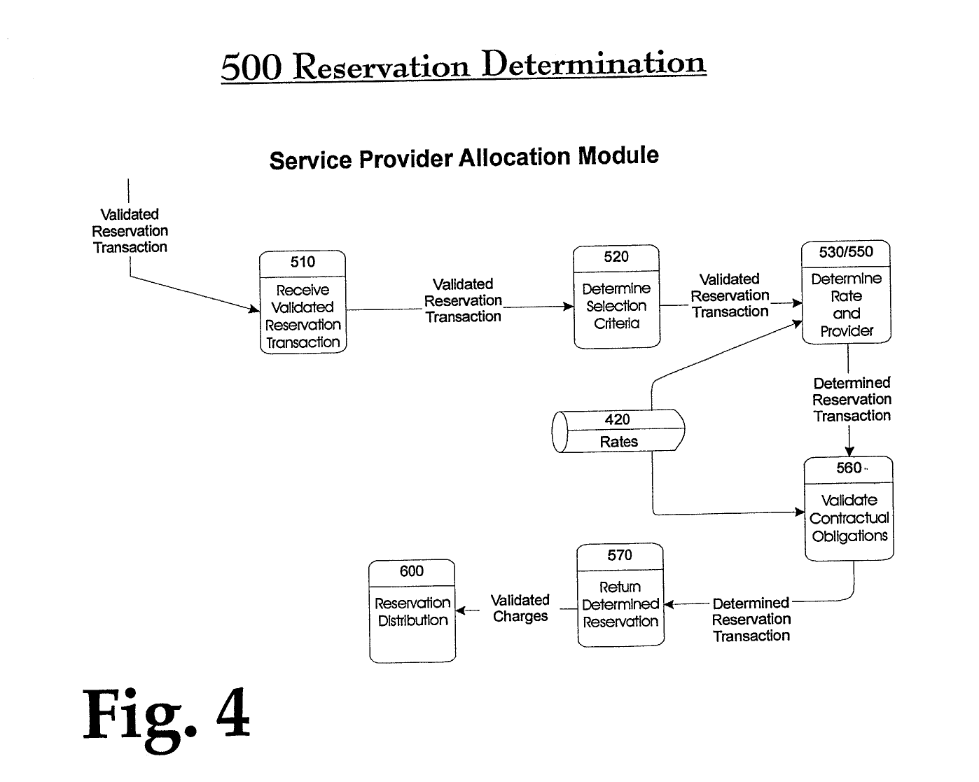

Proceeding to FIG. 4, there is shown the general operation of the service provider allocation module 500. This more particularly includes receipt, at step 510, of the validated reservation transaction from reservation validation step 360. Therefrom, the validated reservation transaction is forwarded to step 520, the function of which is to determine provider selection criteria, in terms either of rate or provider selection, which occurs through algorithms 530 (rate) and 550 (provider), as set forth below. After algorithms 530 and 550 have resolved the issues of rate and provider, responsive to a given reservation request, this information is forward to step 560 at which the contractual obligations of the service provider relative to the transaction are validated. Thereupon, the reservation is deemed to be “determined” such that the “determined reservation” can, at step 570, then be forwarded onto a service provider distribution module 600.

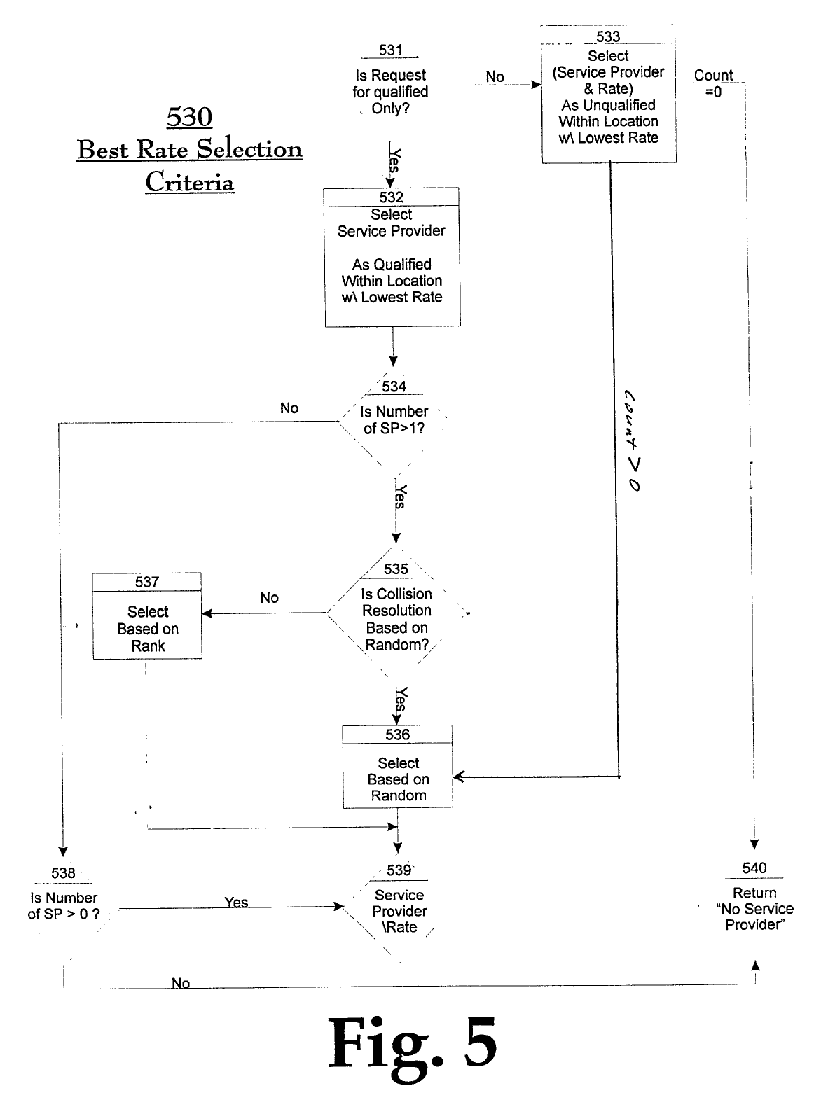

Turning to FIG. 5, the inner workings of best rate selection algorithm 530 of the service provider allocation module may be more fully appreciated. More particularly, algorithm 530 will, at query step 531, first ask if the request is for “qualified” service providers only. In most cases, the term “qualified” will relate to rules that a corporate travel manager of a customer has predetermined in accordance with company policy, for example, vehicle type, driver qualifications, insurance of provider, number of years in business, historic timeliness timelines of service, language requirement of the driver, and the like. Accordingly, a centralized database module which, typically, will be an MSSQL server, operates in association with said reservation database 400 to store the names of service providers who are qualified in accordance with the requirements of either a given customer or with respect to specific system criteria. As such, the rate selection algorithm will not attempt to determine qualification of a service provider but, rather, will search information already stored within the company's centralized database. Proceeding on this basis, step 533 determines if there exists any provider at all for a given location. If not, the algorithm proceeds from step 533 to step 540 which will return a “no service provider” message to the user interface thru database 400 and step 360 (see FIG. 2), this meaning that the program cannot locate service provider, even if not qualified, at the rate requested. If there does exist at least one unqualified provider, the program proceeds from step 536, described below.

Proceeding from Step 531 to Step 532, the system will look for the best rate of a qualified service provider. If there is one or less service providers that are qualified, the program will proceed from query step 534 along the “no” line to query step 538 which will ask if the number of qualified service providers is greater that zero. Accordingly, if the program is able to move from query step 534, i.e., meaning that the number of qualified service providers is one or less, and through query step 538 meaning that the number of qualified service provider is greater that zero, this means that only one service provider that is qualified in the particular graphic area can meet the system and reservation criteria, whereupon that provider and rate information is accessed from the central database module at step 539, and outputted to step 560 (see FIG. 4).

However, in the event that, at query step 534, the number of qualified service providers is greater than one, the system will resolve the question of which service provider to use at query step 535 by making a determination on the basis of a ranking protocol established by the system administrator (step 537). However, a random basis (step 536), or rotation of members of the greater than one set, would be used where the system administrator deems it important not to show bias in favor of one service provider versus another where both are otherwise equally qualified in terms of rate and other applicable criteria in the 530 algorithm. Accordingly, after the determination of service provider has been made on the basis of either rank or random selection, this information is inputted to step 539 which is furnished to said step 560.

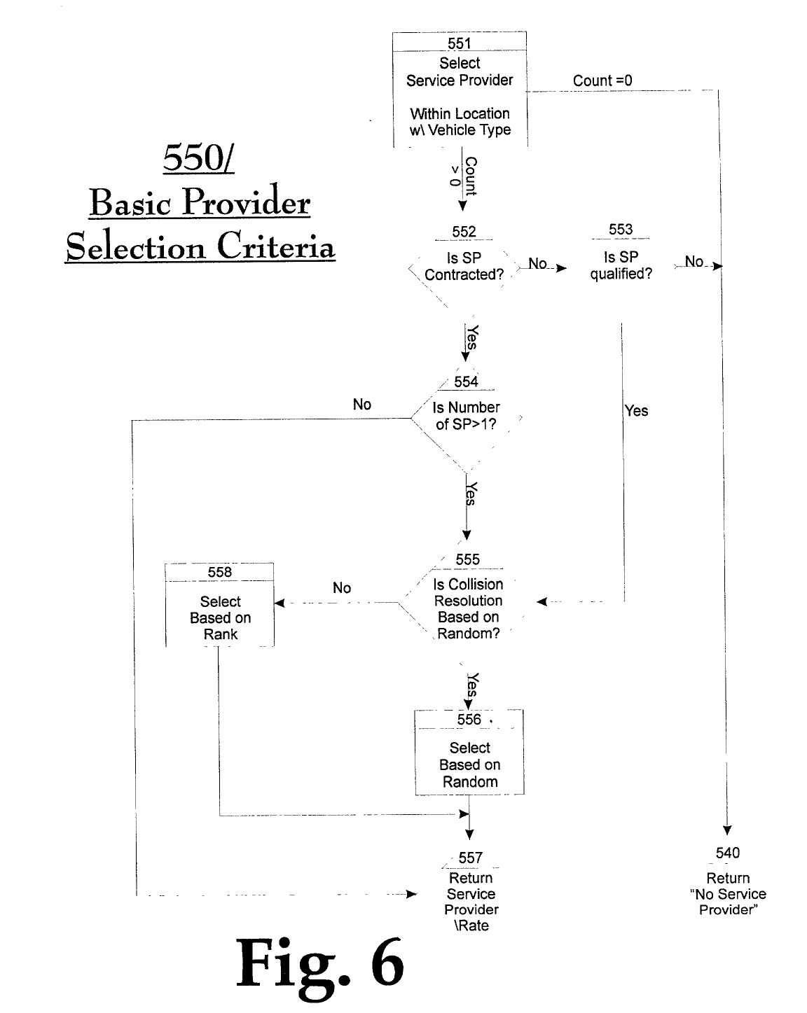

With reference to FIG. 6, the other part of the service provider allocation module is illustrated, namely, the basic provider selection algorithm 550. Therein, depending upon customer preference, as will be the case with customers for whom best rate is not the most important consideration, determination of the service provider will occur through the use of the algorithm shown. Therein, at step 551, the service provider allocation module will search for service providers within a given location, which meets pre-established criteria of, typically, the corporate travel manager of a customer. Such criteria will, as above noted, be a function of such parameters as vehicle type, driver qualification, driver language capability, history of on-time performance, and insurance criteria. At step 551, the central system database will be queried as to the number the service providers that meet the criteria of the reservation requester. If the answer is zero, step 540 will return a “no service provider” message to step 360 of the system above described with reference to FIG. 3. However, if it is determined that there exists more than one service provider meeting the selection criteria, query step 552 will determine whether or not such service providers are contracted by the reservation system.

With regard to any service providers that are not contracted, the system will proceed to query step 553 which will check the service provider against the system administrators criteria of qualification (as opposed to the corporate clients specific criteria). If the service provider is determined to be so qualified, notwithstanding his lack of contract with the system administrator, that service provider's information will be forwarded to query step 555, described below. Returning to query block 552, those service providers deemed to be contracted by the system administrator are forwarded to query step 554 which asks whether the number of such providers is greater than one. In the event of a “no” answer, that will mean that there exists only one service provider meeting the corporate customers criteria and that is properly contracted by the system administration. The name of that provider is then forwarded to query step 577. However, if more than one service provider meets the customer and system administrator contract criteria, that information flows to query block 555 which, in the manner above described with reference to best rate selection algorithm 530, will make a determination on the basis of either system administrator established rank (step 558), rotation of members of the set, or on a random basis (step 556) to thereby generate a service provider name for outputting to step 557, thereby generating a “determined reservation transaction” output from algorithm 550 which becomes the input to said step 560 (see above discussion of FIG. 4) which reviews the service provider's contractual performance in greater detail than does said query step 552 above which only looks for the existence of a contract.

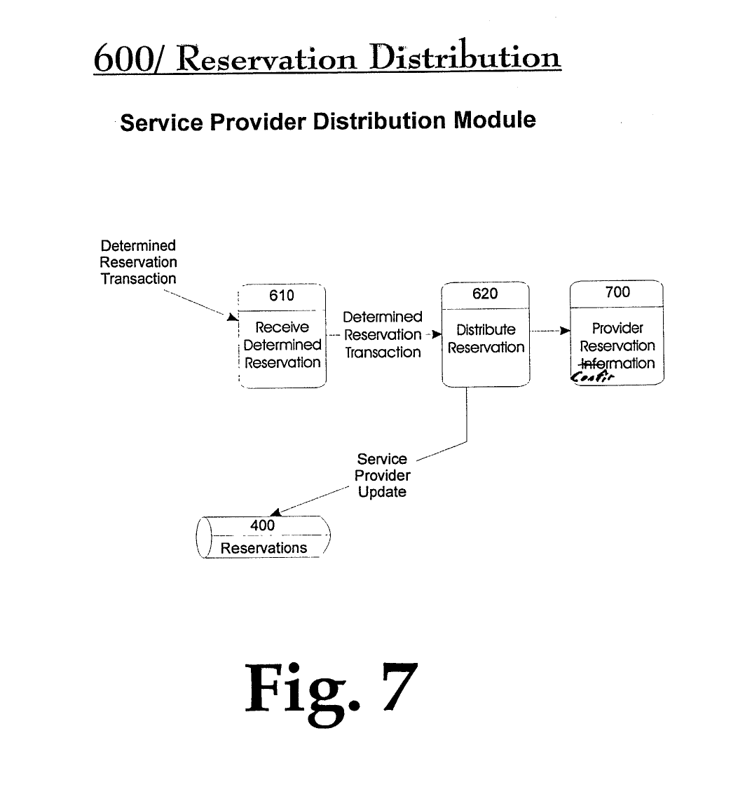

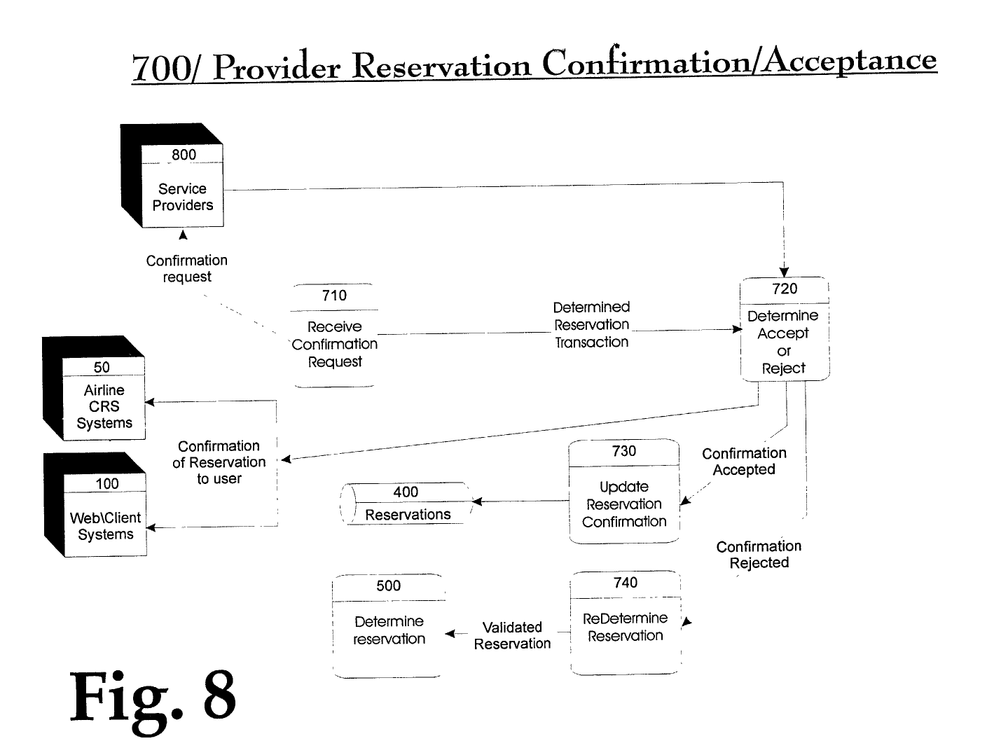

In view of the above, it may be appreciated that, in accordance with the wishes of a given customer, a service provider will be selected on the basis of either best rate (algorithm 530) or upon non-monetary criteria in accordance with the said basic provider selection algorithm 550). That is, either algorithm 530 or 550 will generate an input to said step 560 which will address contractual issues between the system administrator and the service provider, as a part of the service provider allocation module generally shown and described with reference to FIG. 4 above. Thereby, the service provider allocation module 500 provides a “determined,” fully validated, reservation as the input to service provider distribution module 600 which is shown in FIGS. 1 and 7. Therein, a determined reservation transaction is received (step 610) from the allocation module and proceeds at step 620 to forward the determined reservation to a provider reservation confirmation routine 700. (See FIGS. 7 and 8.)

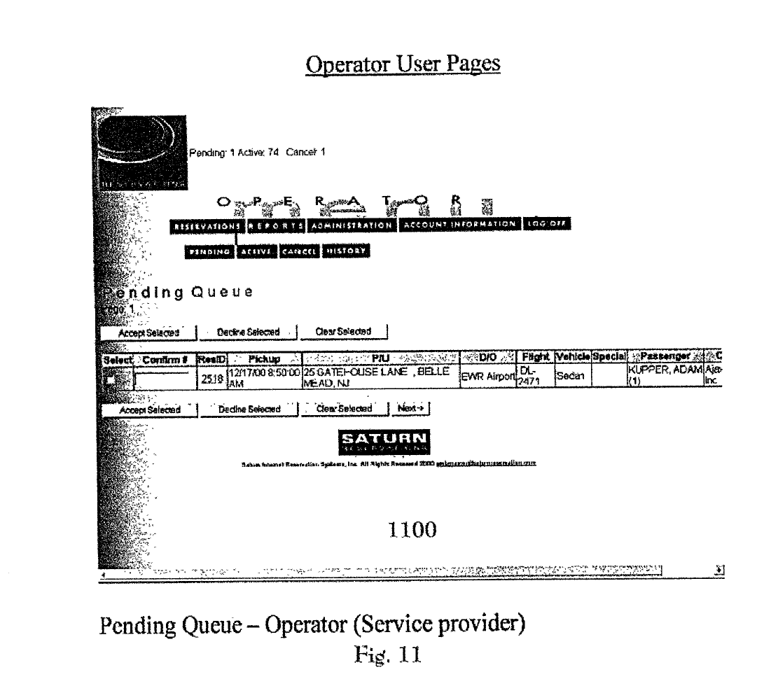

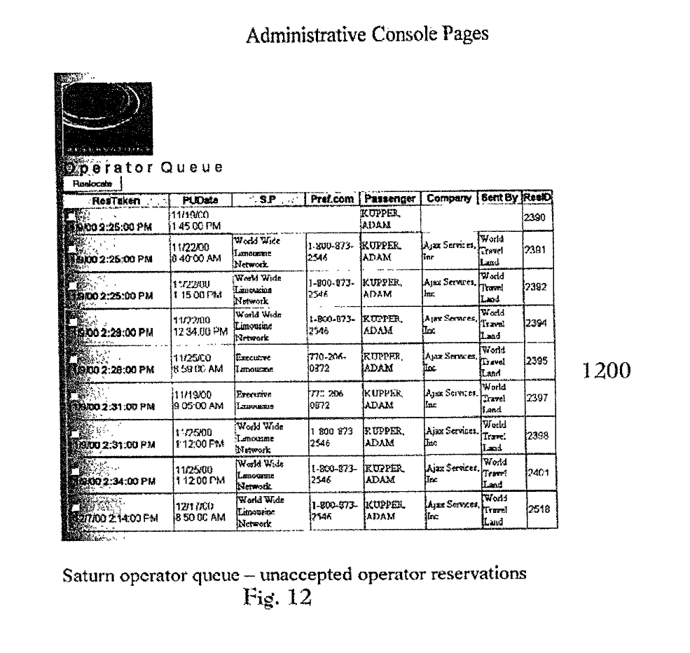

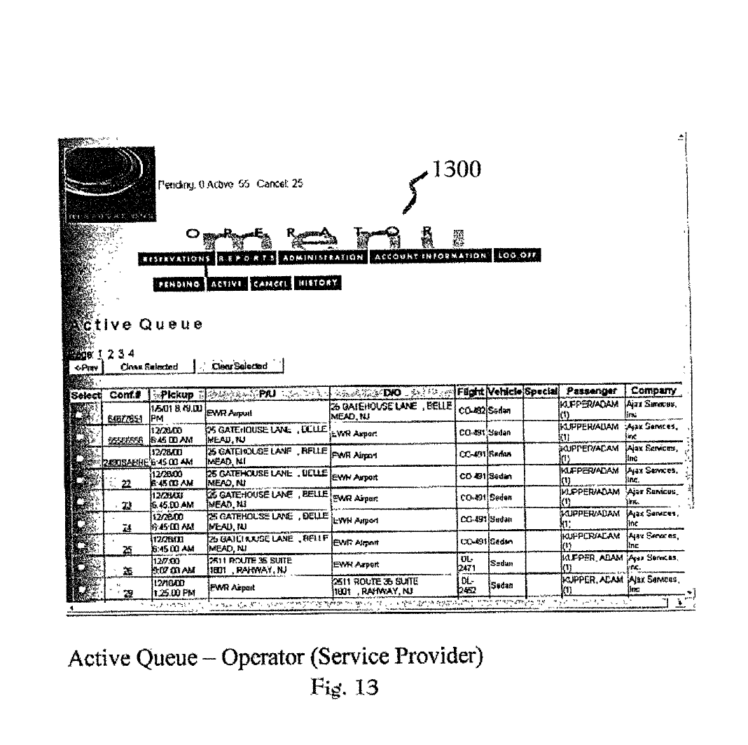

Proceeding to said routine 700, this part of the program will, at step 710, generate a confirmation request to the selected service provider 800 who will communicate its acceptance or rejection of the transaction, which is then processed by the system at step 720. The confirmation request appears, upon the monitor of a service provider, in the manner shown on screen 1100 of FIG. 11. The appearance of an unaccepted (but not yet rejected) determination of acceptance or rejection (step 720) at the administrative console of the host server is shown in FIG. 12 as screen 1200. At this point, the system operator is awaiting response from service providers deriving from step 720. If the reservation is confirmed (accepted) by the service provider, this confirmation is digitally communicated to customers 50/100, noted at step 730 (see FIG. 8) and entered into the reservation database 400. The appearance of accepted reservations upon the monitor of a service provider is shown as screen 1300 in FIG. 13. However, if the service provider 800 rejects the offer of reservation, the same is noted at step 740 which returns the program to the service provider allocation module 500 to re-determine the reservation, however, excluding from consideration the service provider that rejected the offer of reservation.

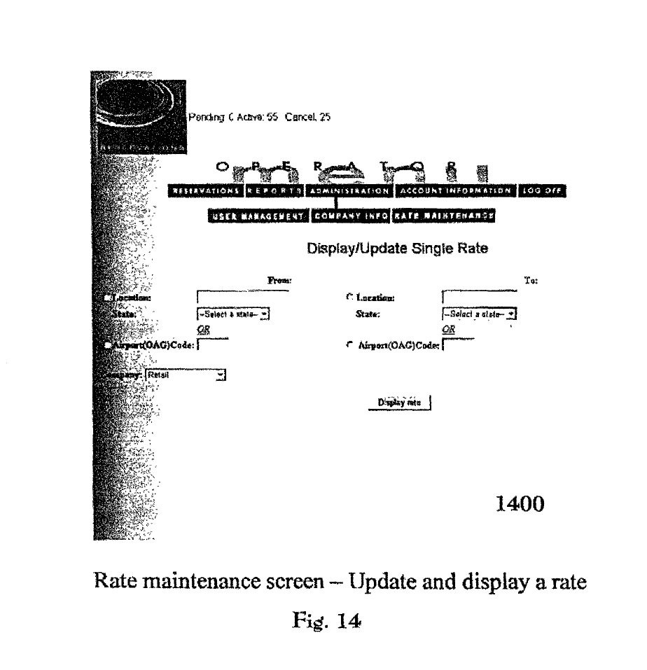

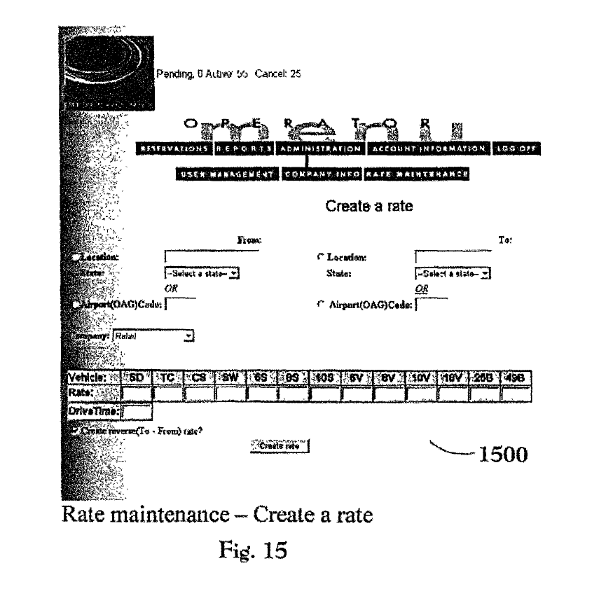

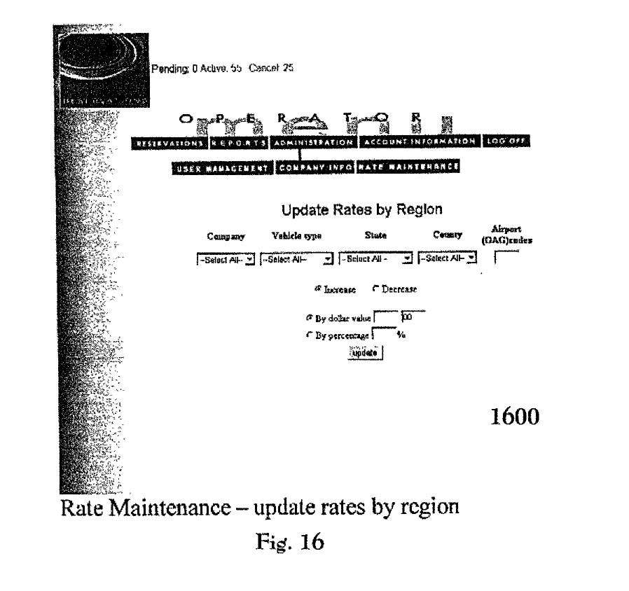

In FIGS. 14 thru 16 are shown rate related screens used by system service providers. More particularly, shown in FIG. 14 is a service provider screen 1400, that is, a screen by which any member provider may display and update any of its rates, which information is then made available to the host server and clients. In FIG. 15 is shown a second rate maintenance screen 1500, that is a screen 15 for generating of a rate when a new location or new vehicle type has come on line for a given service provider. In FIG. 16 is shown a third rate maintenance screen, that is, a screen 1600 for updating of rates on a regional basis. Such a screen is particularly applicable where a quote is needed for a ground transportation rate at a remote location such as a client destination at the end of a plane flight.

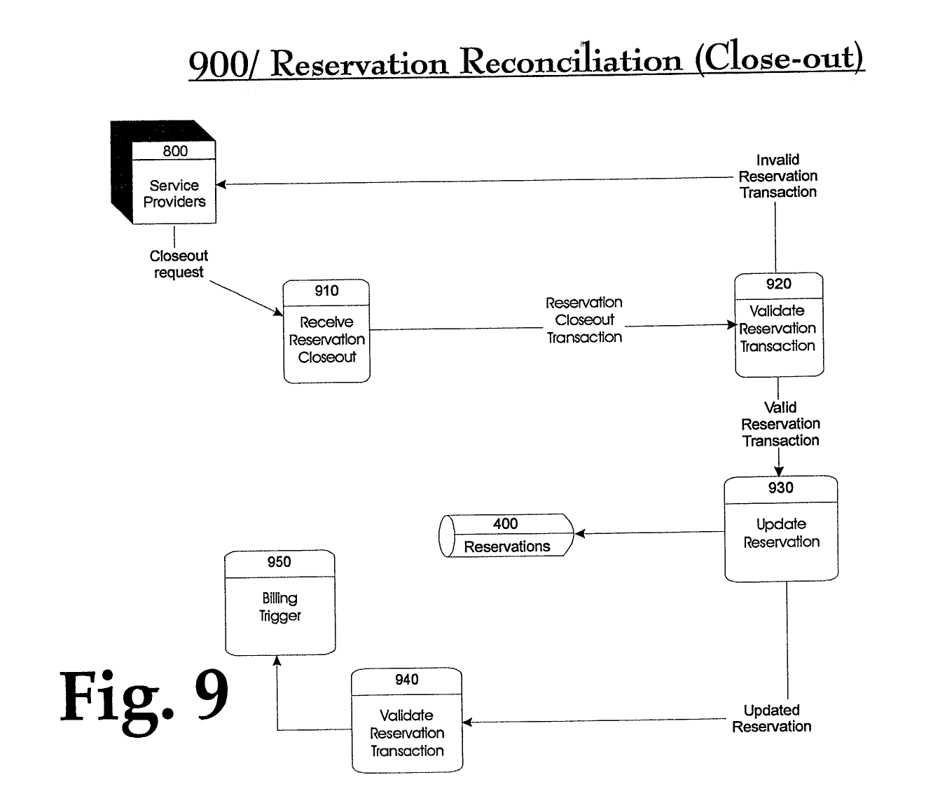

The inventive system concludes with a reservation reconciliation (closeout) 900 which initiates with a close-out request (see FIG. 9) from the selected service provider (step 910) and continues to step 920 which validates the reservation transaction in terms of billing related problems such as a bad account or the use of an invalid credit card by a prospective customer logging on through the Internet, thereby resulting in an invalidation of the reservation transaction as is indicated by the line above step 920, declining the job. However, if the reservation is (in a billing sense) determined to be valid, the reconciliation program will continue to step 930 thereby updating the reservation database 400. The validated reservation transaction then proceeds to step 940 to generate a billing trigger 950 for purposes of billing to the customer in accordance with the billing/invoicing protocol stored within the centralized database module so that the customer is advised of the debit in a manner and fashion historically established by the parties.

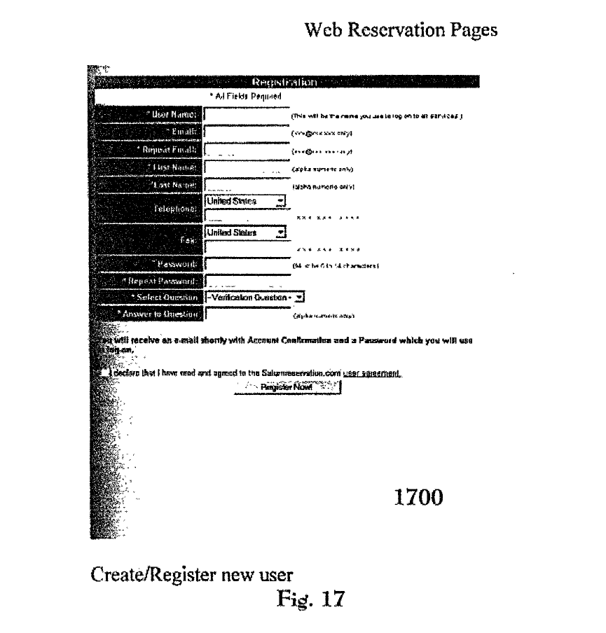

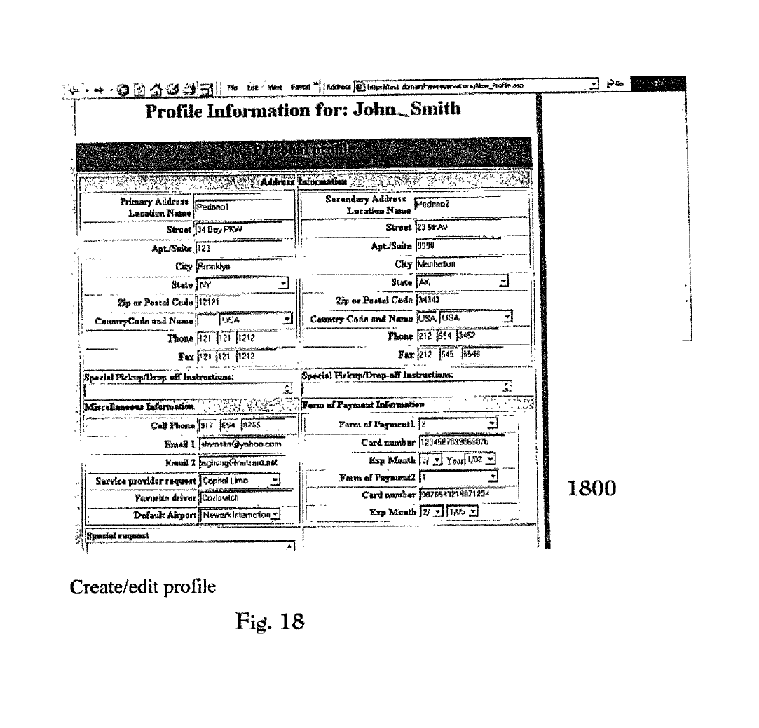

Shown in FIGS. 17 thru 22 are various web pages for use in connection with a web based reservation request from a web base 50 or pre-existing non-CRS clients 100 above described. At page 1700 of FIG. 17 a new user may register with the present system; therein a password is assigned to that user. Screen 1800 of FIG. 18 is a profile web page which captures information of which is then stored within the reservation database 400.

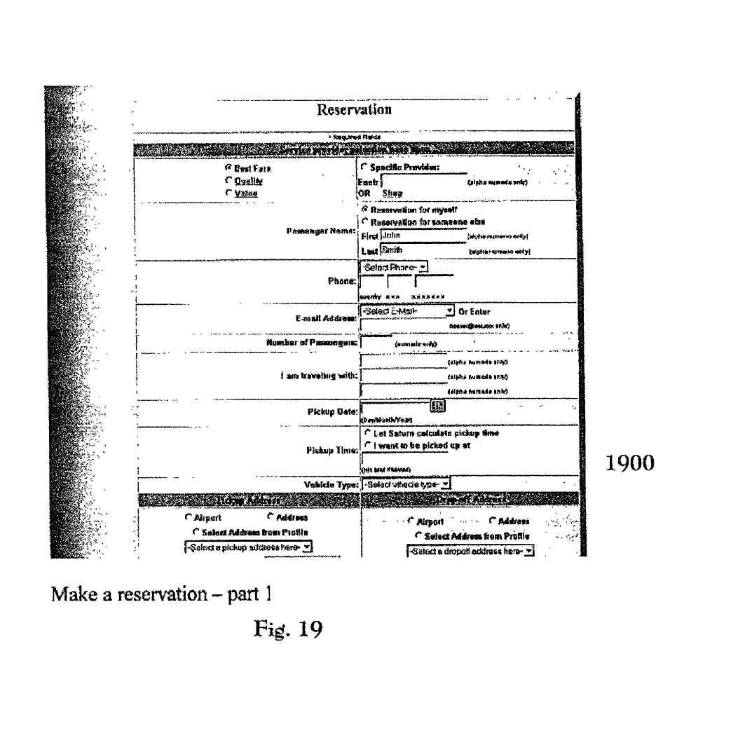

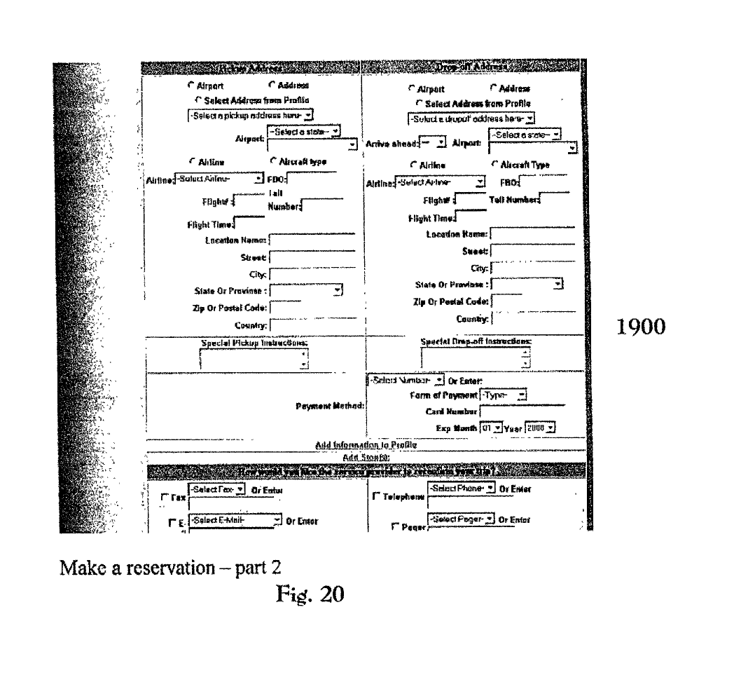

FIGS. 19 and 20 show an on-line reservation form 1900 having information of a type which, after reservation request 100, will travel through acquisition step 200 (see FIGS. 1-2) which includes queue detect module 210 and parsing module 220-240, to provide a reservation transaction input to reservation module 300 above described. FIG. 20 is a lower part of form 1900 from the reservation form of FIG. 19. Reservation database 400 therein secures all reservation particulars from the prospective passenger, namely, name, phone, e-mail address, number of passengers, names of accompanying passengers, pick-up date, pick-up time, preferred vehicle type, destination, flight number (if transportation is to an airport), flight destination, special pickup instructions, special drop off instructions and mode of payment.

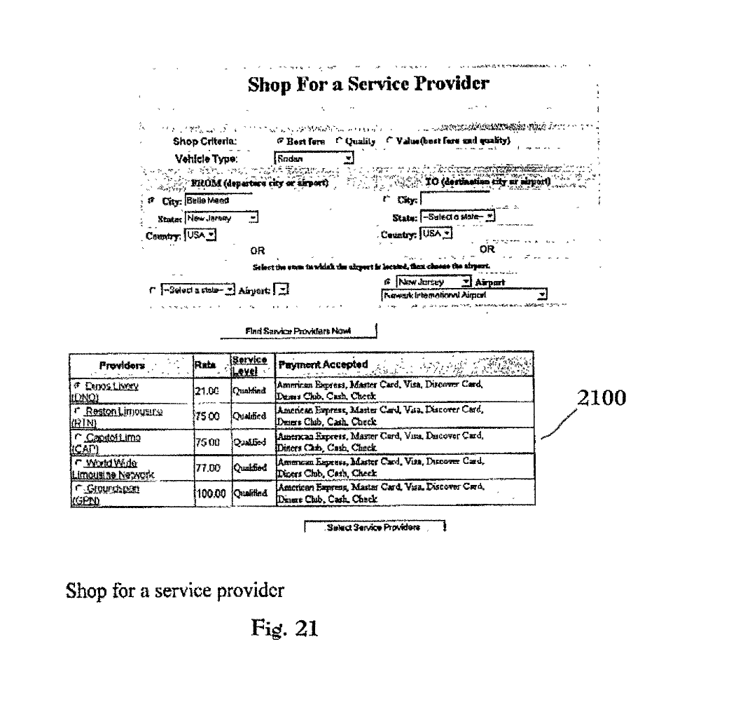

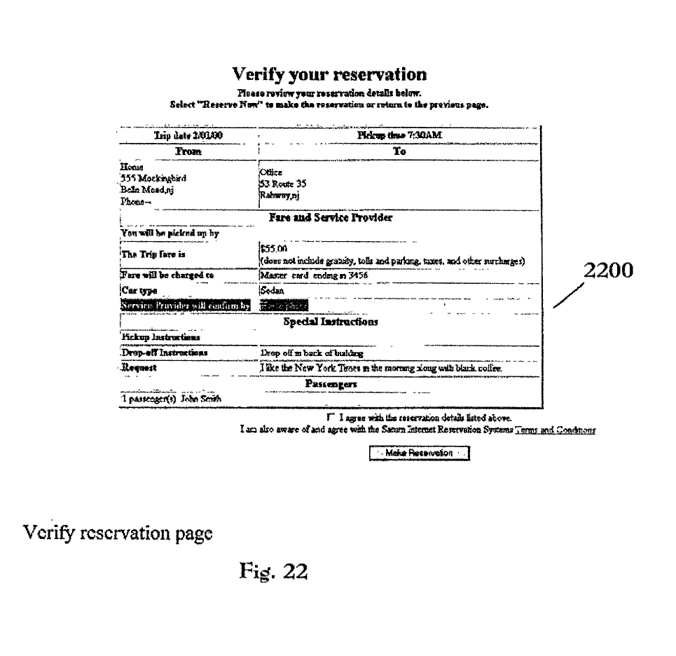

Shown at screen 2100 of FIG. 21 is a web page at which a user may “shop” for a service provider, this, however, with reference to the intelligent software algorithm parameters above set forth, with i.e., the selection criteria above described with reference to FIGS. 5 and 6. In other words, while the client may indicate a preference for a vehicle type, a best fare criteria, a best quality criteria, or a value criteria, that is, a combination of best fare and quality, the customer is not able to override certain server generator criteria that are programmed into the algorithms of FIGS. 5 and 6, for example, insurance levels held by a service provider, server determined minimum qualifications and the like. Where more than one service provider is able to meet a given customer's criteria, selection may occur either by random, by rotation, by server ranking or, as is shown in FIG. 21, the prospective customer may make a selection between the service providers which are available that meet all of client criteria, which are listed in the manner shown therein. Verification of a reservation is shown on screen 2200 of FIG. 22 wherein the customer is provided with a further opportunity to provide pickup instructions, drop off instructions, and special requests to the host server.

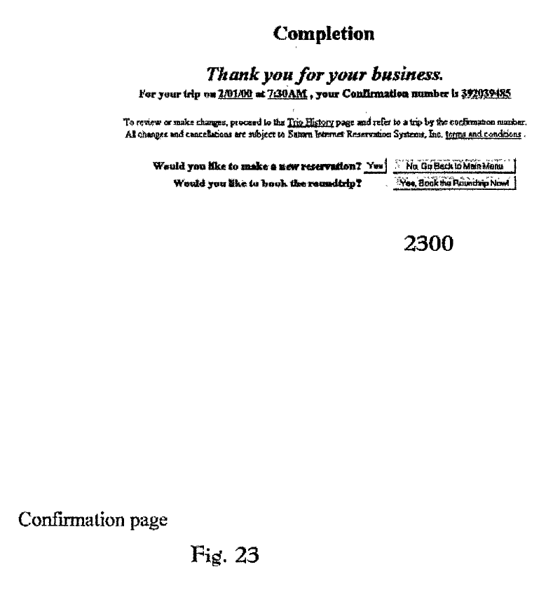

Shown in FIG. 23 is Internet confirmation page 2300 which provides inputs to queue detect module 210 of reservation acquisition step 200 described above.

It is to be understood that the above-described program is dependent upon a centralized server of the MICROSOFT NT cluster type (MSSQL server) and the ODBC interface layer module referenced in the Summary of the Invention above. Further, the instant system will be employed within the context of a corporate administration and recording module, which will be usable through a system operations console and administration module.

Accordingly, while there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the herein.

We claim:

1. A ground transportation reservation system, comprising:
(a) at least one remote client computer inclusive of means for generating and transmitting reservation requests and related data therefrom;
(b) at least one remote service provider computer;
(c) a local host computer and host server having a network connection with both of said remote computers, said connection allowing data transfer between said host, and a client and a service provider respectively;
(d) within said host server, means for acquisition and formatting of data of a received reservation request to form a reservation record;
(e) means for validating said reservation record, for making later changes thereto, and entering said validated record into a first data structure of an operating system of said host server;
(f) an intelligent software agent comprising an algorithm for selecting a service provider for task execution of said validated record, said algorithm comprising:
(i) a second data structure comprised of member service providers;
(ii) means for applying combinations of client and host-server specified criteria of provider rates service, geography, vehicle type, vehicle availability, personnel inclusive of languages spoken, insurance type held by service provider, and ranking by server-determined qualification, to said validated record; and
(iii) means for resolving ties or deadlocks between providers selected on a basis of said means (ii) selectable including either said server ranking of means (ii), rotation, or a random function;
(g) means for advising a first selected service provider through said network connection, of its selection for execution of said reservation record;
(h) means for obtaining a confirmation of acceptance of an offer of said record, from said selected provider;
(i) means for reiterating use of said intelligent agent if said first selected provider declines execution of said reservation record or does not respond to an offer thereof; and
(j) means for entering all accepted records into a third data structure and advising said client of the identity of a finally selected provider and the itinerary associated therewith.

2. The system as recited in claim 1, further comprising:
a graphical user interface at said host computer.

3. The system as recited in claim 2, further comprising:
a database of client preference parameters for use by said (f(ii) of said algorithm.

4. The system as recited in claim 3, in which said client-to-host data transfer occurs within a queue type date structure.

5. The system as recited in claim 3 in which said client computer comprises a travel agency legacy system.

6. The system as recited in claim 3 in which said network connection of a client comprises an Internet connection.

7. A ground transportation reservation system, comprising:
(a) at least one remote client computer inclusive of means for generation and transmitting reservation requests and related data therefrom to a centralized host computer server;
(b) said centralized host computer server comprising means for:
(i) receiving reservation requests in a time-based queue data structure;
(ii) acquisition and formatting of data of a received reservation request to form a reservation record based upon said reservation requests and user criteria;
(iii) validating said reservation record, making changes thereto, and entering said validated record into a reservation database;
(iv) monitoring said queue data structure for changes to said validated record, and dynamically generating an updated reservation record responsive to reservation information changes;
(v) validating said updating reservation record and entering said record into said reservation database;
(vi) transmitting said updated reservation record to said remote client computer; and
(vii) receiving confirmation of said updated record from said remote client computer.
(c) at least one remote service provider computer inclusive of means for accepting or rejection of a validated reservation record from said centralized server; and
(d) an intelligent software agent for selecting a service provider for client task execution of said validated record.

8. The system as recited in claim 7 in which said intelligent agent comprises an algorithm for selecting a service provider for client task execution, said algorithm comprising:
i. a data structure comprised of member service provider;
ii. means for applying to said validated record combinations of client and server specified criteria of provider rates, geography, vehicle type, vehicle availability, personnel inclusive of languages spoken, insurance type held by service provider, and ranking by server-determined qualification; and
iii. means for resolving deadlocks between providers selected as a result of said mean (ii) in selectable in accordance with either said server ranking, rotation of a list of qualified service providers within a given geography, or a random function relative to such said list.

9. The system as recited in claim 8, further comprising:
means for reiterating use of said intelligent agent if a first selected service provider declines execution of said reservation record or does not respond to an offer thereof.

10. The system as recited in claim 9, further comprising:
means for entering all accepted records into a further data structure and advising said client of the identity of a finally selected provider and the itinerary associated therewith.

11. The system as recited as recited in claim 9, further comprising:
means for remote client access to said intelligent software agent to enable a potential client to participate in service provider selection and use of parameters defined by said intelligent agent.
